(19) United States
(12) Patent Application Publication
(10) Pub. No.: US 2021/0360915 A1
(43) Pub. Date: Nov. 25, 2021

(54) CRYOPRESERVING COMPOSITIONS

(71) Applicant: UNIVERSITY OF WARWICK, Coventry Warwickshire (GB)

(72) Inventors: Matthew GIBSON, Coventry Warwickshire (GB); Muhammad HASSAN, Coventry Warwickshire (GB); Alice FAYTER, Coventry Warwickshire (GB)

(21) Appl. No.: 16/981,373

(22) PCT Filed: Mar. 15, 2019
(86) PCT No.: PCT/GB2019/050732

§ 371 Date: Sep. 16, 2020

(30) Foreign Application Priority Data
Mar. 16, 2018 (GB) 1804227.5

(51) Int. Cl. A01N 1/02

(52) U.S. Cl. CPC A01N 1/0221

(57) ABSTRACT

The present invention relates to cryopreserving compositions which are suitable for the cryopreservation of biological materials, e.g. cells and proteins. The cryopreserving compositions comprise specified concentrations of polyvinyl alcohol (PVA) and poly-ethylene glycol (PEG). The invention also relates to process for producing cryopreserved biological materials.

The present invention relates to cryopreserving compositions which are suitable for the cryopreservation of biological materials, e.g. cells and proteins. The cryopreserving compositions comprise specified concentrations of polyvinyl alcohol (PVA) and poly-ethylene glycol (PEG). The invention also relates to process for producing cryopreserved biological materials.

Storage of cells is useful for a variety of industries from molecular research to probiotics in the food industry. There are various ways in which to store cells in inactive states, but the most widely used method is cryo-storage. However, cryo-storage of cells is afflicted by the formation of ice crystals around the cells. These crystals can disrupt the cell wall causing the cells to become unviable. The issue of ice crystallisation (and recrystallization after freeze-thaw cycles) in cellular samples has traditionally been alleviated by the addition of organic solvents, such as DMSO or glycerol. However, these solvents must be present at relatively high concentrations (˜10% DMSO, or 10-25% glycerol for bacterial cells) leading to reduced cell survival due to solvent toxicity. The solvents can also have unwanted interactions with any plastic packaging used to store or transport the cells, as well as rendering the samples unsuitable for use in food-grade applications of cells.

Proteins (e.g. enzymes and antibodies) are widely used in molecular biotechnology and as therapeutics, but require storage in high concentrations of solvents (or osmolytes) such as glycerol when frozen, which have the antagonistic effect of inhibiting protein function in addition to the cryo-protective properties they impart. This ‘trade-off’ between preservation and activity ultimately makes the storage and transport of proteins and biotherapeutics difficult. Loss of protein activity under cryogenic conditions generally occurs due to the formation of protein aggregates, which is related to the size of the ice crystals formed during freezing. Interference by existing small molecule cryo-protectants (e.g. trehalose and glycerol) can also impact upon protein activity, requiring dilution upon thawing. There is therefore a need to improve the efficiency of the storage and supply-chain of therapeutic enzymes and antibodies.

Polyvinyl alcohol (PVA) is known to have ice recrystallisation inhibitory (IRI) properties and it is non-toxic. PVA is also not cell penetrative and therefore is simple to remove post-cryopreservation.

The use of PVA has facilitated a considerable reduction in the time between removal from the cryopreservation temperature to having transplant-ready cells by obviating the need for removal of organic solvents. It also avoids the use of toxic organic solvents thus increasing the safety of the cryopreservation process. PVA may also be used at considerably lower concentrations than the previously-used organic solvents.

The invention provides compositions and processes for the storage and/or transport of micro-organisms (e.g. cells) and proteins by using poly(vinyl alcohol) together with poly(ethylene glycol). One embodiment of the composition of the invention is shown herein to result in a 4-fold increase in the recovery of E. coli cells post-thawing, compared to glycerol, utilising significantly lower concentrations of cryo-preservatives. The compositions may be used in the cryopreservation of a range of cells including Gram negative, Gram positive and Mycobacteria strains. The compositions also have advantageous properties when storing proteins.

The cryo-preservative compositions of the invention should enable a transition away from traditional solvent-based compositions and they have applications from molecular biology to food science.

It is therefore an object of the invention to provide enhanced cryopreservation compositions—for both cells and proteins—which increase cell survival rates and protein activity rates, post-thawing.

In one embodiment, the invention provides a cryopreserving composition comprising:
(a) 0.1-40 mg/mL polyvinyl alcohol (PVA), and
(b) 10-400 mg/mL poly-ethylene glycol (PEG).

In a further embodiment, the invention provides a cryopreserving composition comprising:
(a) 0.1-20 mg/mL polyvinyl alcohol (PVA), and
(b) 10-200 mg/mL poly-ethylene glycol (PEG),
   wherein the composition additionally comprises biological material.

Preferably, the PVA has a weight average molecular weight of 5-40 kDa. Preferably, the PEG has a weight average molecular weight of 1-15 kDa.

As used herein, the term “cryopreserving composition” refers to a composition which is suitable for the storage of biological material (e.g. cells, tissues, organs and biological molecules) at temperatures below 4° C.

The cryopreserving composition comprises polyvinyl alcohol (PVA). As used herein, the term “PVA” refers to polyvinyl alcohol, i.e. (CH₂CHOH)ₙ wherein n>2, or a derivative thereof or a co-polymer comprising PVA. PVA is commercially available (e.g. Sigma Aldrich/Merck) in a variety of different molecular weights and degrees of hydrolysis.

The weight average molecular weight of the PVA may be from 1 kDa to 200 kDa. Examples of preferred PVA ranges include those comprising PVA having a weight average molecular weight in the following ranges: 1-5 kDa, 5-10 kDa, 7-15 kDa, 10-15 kDa, 15-20 kDa, 20-25 kDa, 25-30 kDa, 30-35 kDa, 35-40 kDa, 40-50 kDa, 50-60 kDa, 60-70 kDa, 70-80 kDa, 80-90 kDa, 90-100 kDa, 100-120 kDa, 120-140 kDa, 140-160 kDa, 160-180 kDa or 180-200 kDa. Other preferred weight average molecular weights are 1-80 kDa and 3-50 kDa.

In some preferred embodiments of the invention, the PVA may have a weight average molecular weight of about 1, 2, 3, 4, 5, 6, 7, 8, 9, 10, 11, 12, 13, 14 or 15 kDa. In some other preferred embodiments of the invention, the PVA may have a weight average molecular weight in the range 5-40 kDa or 6-14 kDa, preferably 7-13 kDa, more preferably 8-12 kDa or 9-11 kDa, and most preferably about 10 KDa.

The PVA may be partially hydrolysed, e.g. 80-100% hydrolysed, 90-100% hydrolysed, 98-99% hydrolysed; at least 75, 80, 85, 90, 95 or 99% hydrolysed; or 87-89% hydrolysed. PVAs which are not 100% hydrolysed may also be described as PVA co-poly(vinyl acetate). The PVA may be atactic, syndiotactic or isotactic.

The PVA may be part of a copolymer, e.g. a copolymer with vinyl acetate, ethyl vinyl acetate and/or propyl vinyl acetate.

The final concentration of PVA in the composition (i.e. including the biological material) will generally be in the range 0.1 mg/mL to 50 mg/ml or 0.1 mg/ml to 20 mg/ml, preferably 0.5 mg/mL to 10 mg/mL and more preferably 0.7 mg/mL to 5 mg/mL.

In some embodiments, the final concentration of PVA in the composition is 0.5 mg/mL to 2.5 mg/mL, preferably about 1.0 or 1.5 mg/mL. The above concentrations include concentrations which are insufficient to prevent ice nucleation in the composition.

Generally, the biological material (e.g. cell culture, protein solution, etc.) will be combined in a 1:1 ratio with a cryopreserving composition of the invention to provide the above final concentrations.

The invention also provides ‘concentrated’ compositions wherein the concentration of the PVA in the composition is 0.2 mg/mL to 100 mg/ml or 0.2 mg/ml to 40 mg/ml, preferably 1.0 mg/mL to 20 mg/mL and more preferably 1.4 mg/mL to 10 mg/mL.

The invention also provides ‘concentrated’ compositions wherein the concentration of the PVA in the composition is preferably 1.0 mg/mL to 5.0 mg/mL, preferably about 2 or 3 mg/mL.

Such ‘concentrated’ compositions are suitable for combining 1:1 (vol/vol) with biological material to produce a cryopreserving composition.

In some particularly preferred embodiments, the PVA has a weight average molecular weight in the range 7-13 kDa and it is used in the composition at a final concentration of 0.5 mg/mL to 2.5 mg/mL.

In one particularly-preferred embodiment, the PVA has a weight average molecular weight of about 10 kDa and it is used in the composition at a final concentration of about 1 mg/mL.

Derivatives of PVA within the scope of the invention include alkyl/aryl ester substituted PVA.

This PVA will in general be added to the composition prior to the cryopreservation of the biological material.

The composition comprises polyethylene glycol (PEG). PEG has no ice recrystallization inhibitory activity. As used herein, the term “PEG” refers to polyethylene glycol, i.e. expressed as H—(O—CH₂—CH₂)ₙ—OH, wherein n>2, or a derivative thereof or a co-polymer comprising PEG. The PEG may also have substituted end groups, e.g. substituted by alkyl or aryl chains. It may also have —OH groups at both ends.

PEG is commercially available (e.g. Sigma Aldrich) in a variety of different molecular weights.

The weight average molecular weight of the PEG may be from 100 Da to 100 kDa. Examples of preferred PEG ranges include those having a weight average molecular weight in the following ranges: 200 Da to 50 kDa, 1 kDa to 25 kDa, 2 kDa to 10 kDa, and 3 to 5 kDa. In some preferred embodiments of the invention, the PEG may have a weight average molecular weight of about 4 kDa.

The PEG may be part of a copolymer (not a block copolymer), e.g. a copolymer with propylene glycol.

The final concentration of PEG in the composition (i.e. with the biological material) will generally be in the range 0.1-200 mg/ml, preferably 1-150 mg/ml and more preferably 50-150 mg/ml. In some embodiments, the final concentration of PEG in the composition is in the range 75-125 mg/ml, preferably about 100 mg/ml.

Generally, the biological material (e.g. cell culture, protein solution, etc.) will be combined in a 1:1 ratio with a cryopreserving composition of the invention to provide the above final concentrations. The invention also provides ‘concentrated’ compositions wherein the concentration of the PEG in the composition will generally be in the range 0.2-400 mg/ml, preferably 2-300 mg/ml and more preferably 100-300 mg/ml. Such ‘concentrated’ compositions are suitable for combining 1:1 (vol/vol) with biological material to produce a cryopreserving composition.

In some particularly preferred embodiments, the PEG has a weight average molecular weight in the range 2-10 kDa and it is used in the composition at a final concentration of 50-150 mg/ml. In one particularly preferred embodiment, the PEG has a weight average molecular weight of about 4 kDa and it is used in the cryopreserving composition at a final concentration of about 100 mg/mL.

Derivatives of PEG within the scope of the invention include alkyl/aryl ester substituted PEG.

The PEG will in general be added to the cryopreserving composition prior to cryopreservation of the biological material.

In some particularly-preferred compositions, the cryopreserving composition comprises:

(a) 0.5-5 mg/mL PVA having a weight average molecular weight of 5-15 kDa; and
(b) 50-150 mg/mL PEG having a weight average molecular weight of about 3-6 kDa.

In some particularly-preferred compositions, the cryopreserving composition comprises:

(a) about 1 mg/mL PVA having a weight average molecular weight of about 10 kDa; and
(b) about 100 mg/mL PEG having a weight average molecular weight of about 4 kDa.

The invention also provides ‘concentrated’ compositions ready for combining 1:1 with a biological material, wherein the composition comprises:

(a) 1.0-10 mg/mL PVA having a weight average molecular weight of 5-15 kDa; and
(b) 100-300 mg/mL PEG having a weight average molecular weight of about 3-6 kDa.

In some particularly-preferred compositions, the ‘concentrated’ composition comprises:

(a) about 2 mg/mL PVA having a weight average molecular weight of about 10 kDa; and
(b) about 200 mg/mL PEG having a weight average molecular weight of about 4 kDa.

Such ‘concentrated’ compositions are suitable for combining 1:1 (vol/vol) with biological material to produce a cryopreserving composition.

In the cryopreserving compositions of the invention, the PEG and PVA are preferably not chemically linked.

The cryopreserving composition may additionally comprise one or more of the following: an aqueous buffer (e.g. PBS), an antibiotic, a sugar, an anticoagulant, an antioxidant, glycerol, DMSO and a pH indicator.

In most embodiments, the cryopreserving composition is an aqueous composition or substantially an aqueous composition. The aqueous composition may, for example, be a physiologically-acceptable buffer.

The cryopreserving composition preferably does not contain haemolytic agents, e.g. agents which induce the lysis of red blood cells.

In other embodiments, the cryopreserving composition of the invention additionally comprises biological material. As used herein, the term “biological material” includes cell-containing biological material and biological molecules. The term includes cells, tissues, whole organs and parts of organs. It also includes proteins and nucleic acids, and complexes between proteins and nucleic acids.

In some embodiments, the cryopreserving composition of the invention is frozen, e.g. at a temperature of less than 0° C., more preferably less than −5° C., −20° C. or −60° C.

In some embodiments, the cryopreserving composition may also comprise small amounts of organic solvents such as DMSO or glycerol, but in amounts that are insufficient to promote or induce vitrification.

In some embodiments, the cryopreserving composition comprises 0-10%, preferably, 0-5% or 0-1% and most preferably 0% glycerol.

In some embodiments, the cryopreserving composition comprises 0-10%, preferably, 0-5% or 0-1% and most preferably 0% organic solvents.

In some embodiments, the cryopreserving composition comprises 0-10%, preferably, 0-5% or 0-1% and most preferably 0% DMSO.

In some embodiments, the cryopreserving composition comprises 0-10%, preferably, 0-5% or 0-1% and most preferably 0% trehalose.

The composition is substantially free of vitrification-inducing agents. A “vitrification-inducing agent” is one which is capable of inducing vitrification in the composition at a cryopreserving temperature, e.g. at −20° C. or at the temperature of liquid nitrogen or dry ice. The presence or absence of vitrification of the composition may be established by differential scanning calorimetry and cryo-microscopy. Examples of vitrification-inducing agents include ethylene glycol, glycerol, DMSO, trehalose, propylene glycol, polyethylene glycol and dextran.

In some embodiments, the term “vitrification-inducing agents” includes glass-forming organic solvents, e.g. diols and triols.

As used herein, the term “substantially free of vitrification-inducing agents” means that the cryopreserving composition is not capable of forming a non-crystalline glass-phase at the concentrations used. In general, vitrification-inducing agents are substantially absent from the composition or no vitrification-inducing agents are added to the composition.

The cryopreserved composition is in a non-vitreous state. As used herein, the term “non-vitreous state” means that the composition is not in a non-crystalline glass state.

At the concentrations of the invention, both PVA and PEG are readily soluble in aqueous solutions. The cryopreserving compositions of the invention may be made simply by dissolving appropriate amounts of PVA and PEG in an appropriate buffer (e.g. PBS) and stirring until they are dissolved.

The term “biological material” includes cells. The cells which may be used in the cryopreserving compositions and processes of the invention may be any cells which are suitable for cryopreservation. The cells may be prokaryotic or eukaryotic cells, preferably prokaryotic cells. In some embodiments, the biological material does not comprise eukaryotic cells. The cells may be bacterial cells, fungal cells, plant cells or animal cells. The term “animal cells” includes mammalian cells, and preferably human cells. In some embodiments of the invention, the cells are preferably bacterial cells.

In some embodiments of the invention, the cells are all of the same type. For example, they are all blood cells, brain cells, muscle cells or heart cells. In other embodiments, the biological material comprises a mixture of one or more types of cell. For example, the biological material may comprise a primary culture of cells, a heterogeneous mixture of cells or spheroids. In other embodiments, the cells are all from the same lineage, e.g. all haematopoietic precursor cells.

The cells for cryopreservation are generally live or viable cells or substantially all of the cells are live or viable.

In some embodiments, the cells are isolated cells, i.e. the cells are not connected in the form of a tissue or organ.

In some preferred embodiments, the cells are adipocytes, astrocytes, blood cells, blood-derived cells, bone marrow cells, bone osteosarcoma cells, brain astrocytoma cells, breast cancer cells, cardiac myocytes, cerebellar granule cells, chondrocytes, corneal cells, dermal papilla cells, embryonal carcinoma cells, embryo kidney cells, endothelial cells, epithelial cells, erythroleukaemic lymphoblasts, fibroblasts, foetal cells, germinal matrix cells, hepatocytes, intestinal cells, keratocytes, kidney cells, liver cells, lung cells, lymphoblasts, melanocytes, mesangial cells, meningeal cells, mesenchymal stem cells, microglial cells, neural cells, neural stem cells, neuroblastoma cells, oligodendrocytes, oligodendroglioma cells, oocytes, oral keratinocytes, organ culture cells, osteoblasts, ovarian tumour cells, pancreatic beta cells, pericytes, perineurial cells, root sheath cells, schwann cells, skeletal muscle cells, smooth muscle cells, sperm cells, stellate cells, synoviocytes, thyroid carcinoma cells, villous trophoblast cells, yolk sac carcinoma cells, oocytes, sperm or embryoid bodies; or any combination of the above.

In other embodiments, the cells are stem cells, for example, neural stem cells, adult stem cells, iPS cells or embryonic stem cells.

In some preferred embodiments, the cells are blood cells, e.g. red blood cells, white blood cells or blood platelets.

In some particularly preferred embodiments, the cells are red blood cells which are substantially free from white blood cells and/or blood platelets.

In other particularly-preferred embodiments, the cells are lactic acid bacteria, e.g. Lactobacillus or Lactococcus. Such bacteria are particularly useful for the manufacture of cheese and yogurt.

In other embodiments, the biological material to be cryopreserved is in the form of a tissue or a whole organ or part of an organ. Examples of tissues include skin grafts, corneas, ova, germinal vesicles, or sections of arteries or veins. Examples of organs include the liver, heart, kidney, lung, spleen, pancreas, or parts or sections thereof. These may be of human or non-human (e.g. non-human mammalian) origin.

In some preferred embodiments, the biological material or cells are selected from semen, sperm, blood cells (e.g. donor blood cells or umbilical cord blood, preferably human), stem cells, tissue samples (e.g. from tumours and histological cross sections), skin grafts, oocytes (e.g. human oocytes), zygotes, embryos (e.g. those that are 2, 4 or 8 cells when frozen), ovarian tissue (preferably human ovarian tissue) or plant seeds or shoots.

The biological material may be living or dead (i.e. non-viable) material.

In general, the biological material will be immersed or submerged in the cryopreserving composition or perfused with the cryopreserving composition such that the cryopreserving composition makes intimate contact with all or substantially all of the biological material.

In some embodiments, the biological material comprises or consists of viruses.

The cryopreserving composition of the invention is particularly suitable for the cryopreservation of proteins. As used herein, the term “protein” includes polypeptides and peptides, as well as proteins, polypeptides and peptides which are conjugated to non-protein moieties (e.g. antibody-drug conjugates) and protein/nucleic acid complexes. Examples of preferred proteins include purified enzymes, therapeutic proteins, diagnostic proteins and antibodies. Examples of therapeutic proteins include insulin, erythropoetin, and antibodies (e.g. monoclonal antibodies). Examples of diagnostic proteins include thermostable polymerases (e.g. Taq polymerase), CRISPR enzymes (e.g. Cas9, dCas9, Cpf1) and glucose oxidase.

In yet other embodiments, there is provided a kit comprising:

(a) PVA having weight average molecular weight of 5-40 kDa; and
(b) PEG having a weight average molecular weight of 1-15 kDa, and optionally
(c) one or more components selected from an aqueous buffer (e.g. PBS), a sugar, an antibiotic, an anticoagulant, an antioxidant, DMSO and a pH indicator, and optionally 0-15% glycerol, preferably 0-5% glycerol.

The cryopreserving composition of the invention may be used to store the biological material in a preserved or dormant state (e.g. at its cryopreserving temperature), after which time the biological material may be returned to a temperature above 4° C. for subsequent use.

In general, the cryopreserving composition comprising the biological material will initially be at a temperature above 0° C., e.g. at about 4° C. or at ambient temperature. From there, its temperature will be reduced to the cryopreserving temperature, preferably in a single, essentially uniform step (i.e. without a significant break).

Preferably, the cryopreserving temperature is below 0° C. For example, the cryopreserving temperature may be below −5° C., −10° C., −20° C., −60° C. or in liquid nitrogen or liquid helium, carbon dioxide (‘dry-ice’), or slurries of carbon dioxide with other solvents. In some preferred embodiments, the cryopreserving temperature is about −20° C., about −80° C. or about −180° C.

The invention therefore provides a process for producing a cryopreserved composition comprising biological material, comprising the step:

(a) freezing a biological material at a cryopreserving temperature in a cryopreserving composition of the invention.

In general, the biological material will be placed in the cryopreserving composition and then the temperature will be reduced. The temperature may be reduced directly to the final cryopreserving temperature or first to an intermediate temperature (which may be above or below the final cryopreserving temperature).

The freezing of the biological material may take place in the cryopreserving composition or before the biological material is contacted with or placed in the cryopreserving composition. In other words, the biological material may be frozen before it is contacted with the cryopreserving composition.

If the biological material comprises tissues or organs and/or parts, these may or may not be submerged, bathed in or perfused with the cryopreserving composition prior to cryopreservation.

Preferably, the cryopreserving composition comprising the biological material is not stirred and/or is not agitated during the freezing step.

The process may additionally comprise the step of storing the biological material at a cryopreserving temperature after freezing.

The cryopreserved biological material may be stored for cell, tissue and/or organ banking. In some embodiments, the cryopreserved composition comprising the biological material is stored in a tissue bank or cell-depository institution.

The cryopreserved material may be stored at the cryopreserving temperature for any desired amount of time. Preferably, it is stored for at least one day, at least one week or at least one year. More preferably, it is stored for 1-50 days, 1-12 months or 1-4 years. In some embodiments, it is stored for less than 5 years.

The process of the invention may additionally comprise the step of transporting the cryopreserving composition comprising the biological material in a frozen or partially-frozen state to a remote location.

In a preferred embodiment of the invention, there is provided a process for producing a cryopreserved composition comprising biological material, the process comprising the steps:

(a) freezing a biological material, wherein the biological material comprises or consists of prokaryotic (preferably bacterial) cells to a temperature of −70° C. to −200° C. (preferably about −80° C. or about 196° C.) in a cryopreserving composition of the invention; and
(b) storing the frozen biological material at a temperature of −10° C. to −30° C. (preferably about −20° C.).

The rate of freezing may, for example, be slow (e.g. 1-10° C./minute) or fast (above 10° C./min). In some embodiments, the rate of freezing is at least 10° C./minute, preferably at least 20° C./minute, at least 50° C./minute or at least 100° C./minute. In some embodiments, the rate of freezing is between 10° C./minute and 1000° C./minute, between 10° C./minute and 500° C./minute, or between 10° C./minute and 100° C./minute.

Fast rates of freezing induce the production of ice crystals in the composition. Crystals produced in this way are small; they are also generally numerous. Upon warming or thawing of the cryopreserved composition, it has been found that the presence of PVA in the composition inhibits the natural recrystallisation of these small ice crystals into larger ones, thus significantly reducing the cell death which would normally occur at this time.

The most preferred freezing rate in any one particular case will be dependent on the volume of the composition and the nature of the biological material. By following the teachings herein and the above points in particular, the skilled person may readily determine the most appropriate freezing rate in any one case.

Rapid freezing using solid CO₂ slurries or liquid N2 are preferred, which cool at approximately 100° C./min. It is also possible to achieve similar rates using other cryogens which have a temperature which is colder than standard refrigerators (e.g. below −20° C.).

In a preferred embodiment, the PVA is present in the composition at a concentration which is insufficient to prevent ice nucleation (ice formation) in the composition. Under such circumstances, ice may form in the composition.

The invention therefore provides a process as described herein, wherein ice is present in the cryopreserving composition at one or more stages during thawing of the composition.

In some embodiments, the composition is cryopreserved at a rate which induces the production of ice crystals, most preferably small ice crystals, in the cryopreserved composition.

Ice nucleation within the composition may be tested for by differential scanning calorimetry or cryomicroscopy.

The process of the invention may additionally comprise the step of thawing the composition.

In some embodiments, the term “thawing” refers to raising the temperature of the cryopreserved composition or biological material to 0° C. or above, preferably to 4° C. or above.

In other embodiments, the term “thawing” refers to raising the temperature of the cryopreserved composition or biological material to a temperature at which there are no or substantially no ice crystals in all or part of the cryopreserved composition or biological material. Hence the term “thawing” includes complete and partial thawing.

The invention therefore further provides a process for producing a biological material, comprising the steps:

(a) thawing a cryopreserving composition of the invention comprising biological material; and optionally
(b) removing and/or isolating the biological material from the cryopreserving composition.

The process may additionally comprise the step of storing the biological material at a temperature of 0-10° C. after thawing.

The rate of thawing may, for example, be slow (e.g. 1-10° C./minute) or fast (above 10° C./min). In some cases it may be advantageous to thaw slowly. Rapid thawing in a water bath at 37° C. is preferred. Cell recovery is also possible at lower temperatures (e.g. 20° C.).

Alternatively, the temperature of the biological material may be raised to a temperature at which the biological material may be removed from or isolated from the cryopreserved composition (e.g. 4° C. or above); and the biological material may then be stored at this temperature until use.

The term “recrystallisation” is known in the context of cryopreservation to refer to ice crystal growth during warming or thawing. The PVA in the cryopreserved composition of the invention has ice recrystallization inhibitory properties.

After cryopreservation, the biological material may be used for any suitable use, including human and veterinary uses. Such uses include for tissue engineering, gene therapy and cellular implantation.

The invention also provides the use of a composition of the invention for the cryopreservation of a biological material.

In a particularly preferred embodiment, the invention provides the use of a composition comprising:
(a) PVA having weight average molecular weight of 5-40 kDa; and
(b) PEG having a weight average molecular weight of 1-15 kDa,
   for the cryopreservation of a biological material.

The disclosure of each reference set forth herein is specifically incorporated herein by reference in its entirety.

### BRIEF DESCRIPTION OF THE FIGURES

FIG. 1 shows IRI activity of macromolecules used in this study. MLGS refers to the mean largest grain size, relative to a PBS control.

FIG. 2 shows A) Recovered colonies of E. coli after 7 freeze (−196° C.) thaw (20° C.) cycles. B) Recovered colonies of E. coli after overnight incubation with cryoprotectants. Concentrations of cryoprotectants; [Glycerol]=25 wt %; [AFPIII]=1 mg·mL⁻¹; [PVA]=1 mg·mL⁻¹; [PEG/AFPII]=100+0.01 mg·mL⁻¹; [PEG/PVA]=100+1 mg·mL⁻¹; [poly(ampholyte)]=50 mg·mL⁻¹). Control is LB media alone.

FIG. 3 shows A) Effect of varying PEG concentration on number of recovered E. coli colonies after 7 freeze (−196° C.) thaw (20° C.) cycles; and B) Live/dead viability testing on E. coli immediately after freeze/thaw cycle, with percentage of green (intact membrane) bacteria determined by confocal microscopy. [PEG/PVA]=100+1 mg·mL⁻¹ respectively. Error bars represent S.D. from at least 3 repeats.

FIG. 4 shows normalised cell recovery for 3 different bacteria upon addition of different cryoprotectants after 7 freeze/thaw cycles. Values obtained are normalized to themselves.

FIG. 5A shows E. coli growth profiles after 7 freeze (−196° C.)/thaw (20° C.) cycles then inoculation into LB media. FIG. 5B shows cell growth profiles for E. coli (5 μL starting culture) after 7 freeze (−196° C.) thaw (20° C.) cycles with PEG alone, then inoculated into LB media.

FIG. 5C shows cell growth profiles of E. coli after 7 freeze (−196° C.) thaw (20° C.) cycles for different molecular weight PEGs ranging from 200 Da to 8 kDa each supplemented with 1 mg·mL-1 PVA (10 kDa) then inoculated into LB media. [PEG]=100 mg·mL⁻¹.

FIG. 5D shows cell growth profiles of E. coli with the indicated molecular weight PVAs in combination with different molecular weight PEGs (200 Da-8 kDa) after 7 freeze (−196° C.) thaw (20° C.) cycles then inoculation into LB media. [PEG]=100 mg·mL⁻¹; [PVA]=1 mg·mL⁻¹.

FIGS. 6A-B show ice recrystallization inhibiting polymer mediated protein storage. A) example ice crystal wafers grown with and without added PVA. Scale bar—100 μm; B) Recovery of β-gal activity after freezing for 3 days at −20° C., as % of fresh, unfrozen protein. Error bars are S.D. from n=6, ** represents p<0.01 relative to PBS buffer control. PEG, PVP, Trehalose and HES at concentration of 100 mg·mL⁻¹, PVA at 1 mg·mL⁻¹.

FIGS. 6C-D show dilutions of PEG and PVA frozen and stored for 3 days at −20° C. C) Serial dilution of PEG, with 1 mg·mL⁻¹ PVA; D) Serial dilution of PVA, with 100 mg·mL⁻¹ PEG. ** Represents p<0.01 relative to PBS buffer, error bars are calculated from minimum of 6 repeats. Recovery expressed as a percentage of fresh unfrozen B-Gal.

FIG. 7 shows the mechanism of protein protection. A) Protein freeze/thaw recovery upon addition of alternative IRI polymer p(ampholyte) following β-Gal storage for 3 days at −20° C., as % of fresh, unfrozen protein. Concentrations as in FIG. 6, but p(ampholyte) used at 30 mg·mL-1. Error bars are S.D. from a minimum of six repeats; B) DLS analysis of protein aggregation post freezing compared to fresh protein.

FIG. 8 shows retention of β-Gal function. A) Protein activity after 1 hour incubation in the cryostorage solutions without freeze/thaw; B) Protein recovery after 4 weeks storage at −80° C.

FIG. 9 shows protein activity recovery after 3 days storage at −20° C. A) Glucose oxidase recovery as percentage of unfrozen control.; B) Taq polymerase activity recovery expressed as number of threshold cycles (lower is more active). ** represents p<0.01 compared to control, error bars are from a minimum of 6 repeats. C+D show fluorescence recovery of GFP after freeze (−20° C.)/thaw (20° C.). All solutions containing 100 mg·mL⁻¹ PEG plus PVA concentration indicated in the insert. C) PVA 10 kDa; D) PVA 23 kDa.

FIG. 10 shows A) Rabbit IgG activity recovered after 3 days storage at −20° C.; Activity reported relative to fresh antibody in a surface binding assay. ** represents p<0.01, error bars are from a minimum of 6 repeats; B) DLS curves of insulin before (solid) and after (dashed) 12 freeze thaw cycles. In all cases PEG=100 mg·mL⁻¹ and PVA=1 mg·mL⁻¹. C) Average size of insulin aggregates after 6 or 12 FT cycles in indicated conditions. (PEG2 and PEG4 indicate 2 kDa PEG and 4 kDa PEG, respectively.

FIG. 11 shows the number of colonies of E. coli obtained after freezing in liquid nitrogen and storage at −20° C. for one week.

### EXAMPLES

The present invention is further illustrated by the following Examples, in which parts and percentages are by weight and degrees are Celsius, unless otherwise stated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions. Thus, various modifications of the invention in addition to those shown and described herein will be apparent to those skilled in the art from the foregoing description. Such modifications are also intended to fall within the scope of the appended claims.

### Cryopreservation of Cells

### Materials and Methods

### Materials

Poly(ethylene glycol) (200 Da, 400 Da, 1.5 kDa, 4 kDa, 6 kDa and 8 kDa), poly(vinyl alcohol) (10, 23 and 31 kDa), NaCl and ampicillin were purchased from Sigma-Aldrich and used as supplied unless otherwise stated. Imidazole (Merck), dioxane and glycerol (Fisher Chemical), isopropyl-β-D-thiogalactoside (IPTG) (VWR chemical), Novex AP Chromogenic and SYTO-9 (Invitrogen) and Coomassie blue stain (Expedeon) were also used as supplied.

The Escherichia coli (E. coli) BL21(DE3) cells were purchased from New England Biolabs, Bacillus subtilis (B. subtilis) (168 wild type) were donated by Dr Emma Dunham and Mycobacterium smegmatis (M. smegmatis) (Mc2155) was kindly donated by Dr. Elizabeth Fullam, University of Warwick, UK. Monoclonal Anti-polyHistidine antibody produced in mouse, clone HIS-1, ascites fluid and goat anti-Mouse IgG (H+L) secondary antibody (AP-conjugated) were purchased from Sigma Aldrich and used as received.

### Physical and Analytical Methods

Size exclusion chromatography (SEC) analysis was performed using a Varian 390-LC MDS system equipped with a PL-AS RT/MT autosampler, a PL-gel 3 μm (50 Å˜7.5 mm) guard column, two PL-gel5 μm (300 Å˜7.5 mm) mixed-D columns using DMF with 5 mM NH₄BF₄ or THF with 2% TEA (trimethylamine) and 0.01% BHT (butylated hydroxytoluene) additives (depending on system used) at 50° C. as eluent at a flow rate of 1.0 mL·min⁻¹. The SEC system was equipped with ultraviolet (UV)/visible (set at 280 and 461 nm) and differential refractive index (DRI) detectors. NMR spectroscopy (1H, 13C) was conducted on a Bruker Advance III HD 300 MHz, HD 400 MHz, or HD 500 MHz using deuterated solvents from Sigma-Aldrich. UV-VIS spectroscopy measurements were performed on a Jenway 6300 Visible Range Spectrophotometer using an absorbance of 600 nm (OD measurements) and 560 nm (BCA assays). Samples for western blot analysis were resolved on a polyacrylamide gel, transferred to a membrane and detected a using primary (monoclonal anti-polyhistidine) antibody and a secondary (goat anti-mouse IgG (H+L)) antibody. Fast protein liquid chromatography (FPLC) was performed using AKTA pure (GE Healthcare) with a flow rate of 1 mL·min⁻¹ using PBS buffer. A Linkam Biological Cryostage BCS196 with T95-Linkpad system controller equipped with a LNP95-Liquid nitrogen cooling pump, using liquid nitrogen as the coolant (Linkam Scientific Instruments UK, Surrey, U.K.) was used to anneal ice wafers. An Olympus CX41 microscope equipped with a UIS-2 20×/0.45/∞/0-2/FN22 lens (Olympus Ltd., Southend on sea, U.K.) and a Canon EOS 500D SLR digital camera was used to obtain all images. Image processing was performed using ImageJ, which is freely available from http://imagej.nih.gov/ij/. Confocal microscopy was performed on a Nikon Eclipse Ti, an inverted widefield fluorescence microscope, equipped with LED illumination, 100×1.45 NA and 60×1.4 NA objectives, mCherry and GFP filter sets and a 2k×2k sCMOS Andor camera system.

### AFP III Expression and Purification

A plasmid encoding for a hexahistidine-tagged AFP III (T7, pET21b, P19614) was transformed into competent Escherichia coli TOP10 cells (New England Biolabs). Single colonies were selected and grown overnight in 10 mL Lysogeny broth (LB)-medium containing 100 μg·mL-1 ampicillin under continuous shaking (37° C., 180 rpm). Preculture was added (40 mL in 1 L) to LB-medium with ampicillin and grown until OD600=0.6. Isopropyl β-D-1-thiogalactopyranoside (IPTG) was then added to the cells to a final concentration of 0.4 mM to induce protein expression overnight (16° C., 180 rpm). The cells were harvested by centrifugation (4° C., 5000 g, 10 minutes), the supernatant decanted and the cells resuspended in prechilled phosphate buffered saline (PBS) (7 mL, (>18.2Ω mean resistivity, [NaCl]=0.138 M, [KCl]=0.0027 M, and pH 7.4)). Pierce protease inhibitor mini-tablets were added to the suspension and it was passed through a STANSTED ‘Pressure Cell’ FGP12800 homogeniser to undergo lysis. Bugbuster was added (500 μL) and the sample left spinning for 20 minutes. The cell lysate was centrifuged (4° C., 40,000 g, 45 minutes) and the supernatant syringe filtered (0.2 μm) and passed through a pre-equilibrated (20 mL PBS) IMAC Sepharose 6 Fast Flow (GE Healthcare) column charged with Ni(II) ions. The column was washed first with PBS, then with 3 column volumes of 30 mM imidazole in PBS. 300 mM imidazole in PBS was used to elute bound AFP III and the protein purified via fast protein liquid chromatography (FPLC). Western blot and SDS-PAGE gel electrophoresis were used to identify AFP III, and the protein concentration determined using Thermo Scientific Pierce BCA assay kit and verified by measuring absorbance at 280 nm and using beer lambert law.

### LIVE/DEAD Bacterial Viability Test

Following seven freeze/thaw cycles, samples were spun down at 10 000×g for 10 minutes and the supernatant was discarded. An aliquot was taken prior to the freeze/thaw cycle as a live cell control and a further aliquot was heat killed (incubated at 80° C. for 30 mins) for a dead cell control. Cells were re-suspended in 20 μl of 0.85% NaCl solution. 10 μl of this suspension was diluted in 200 μl of 0.85% NaCl solution and the samples were incubated at room temperature for 1 h. Samples were pelleted at 10 000×g for 10 minutes, the supernatant was discarded and the cells were re-suspended in 100 μl of 0.85% NaCl solution. Next, the LIVE/DEAD bacterial viability staining mixture was prepared by mixing SYTO-9 and propidium iodide to final concentrations of 1.67 mM and 10 mM, respectively. The cells were stained by adding 0.3 μl of the staining solution to 100 μl of cell suspension and incubating in the dark for 15 minutes (at room temperature). Slides for microscopy were prepared by trapping 5 μl of the stained bacterial suspension between a slide and a coverslip. Samples were then analysed by means of fluorescent microscopy (at either 100× or 60× magnification) using GFP (excitation 470/40 nm, emission 525/50 nm) and mCherry (excitation 560/40 nm, emission 630/75 nm) filter sets to visualize the SYTO-9 and propidium iodide staining, respectively.

### Example 1: Modified Splat Assay

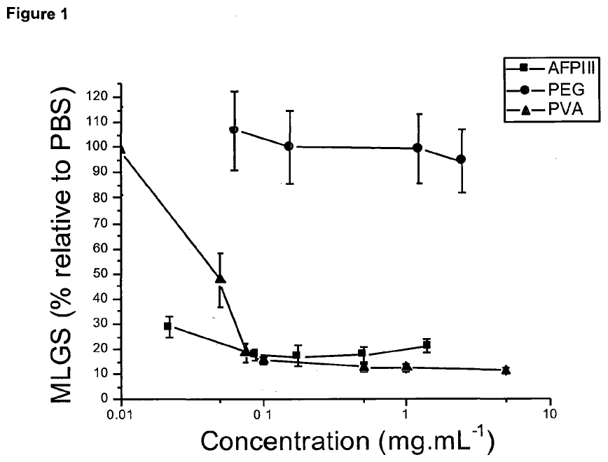

The primary aim of this study was to evaluate the role of ice recrystallization inhibiting (IRI) polymers to enable solvent-free cryopreservation of bacteria. A range of synthetic polymers were selected for this based on their previous use in mammalian cell cryopreservation. Poly(vinyl alcohol), PVA, which is a potent IRI; poly(ethylene glycol), PEG, which has no IRI; a poly(ampholyte), which has weaker IRI activity than PVA but has found application in the cryopreservation of mammalian cells via membrane interactions; and recombinant AFPIII, an antifreeze protein originally isolated from ocean pout. The polymers' IRI activity was evaluated by a modified splat assay. Briefly, ice wafers were nucleated to give small (<10 μm) ice crystals, which were allowed to grow for 30 minutes and then measured. Smaller ice crystals indicated more IRI activity, reported as the mean grain area (MGA) or mean largest grain size (MGLS). The concentrations chosen for the IRI assays related to those used in cryopreservation experiments. A comparison of their IRI activity is shown in FIG. 1.

### Example 2: Cryopreservation Experiments

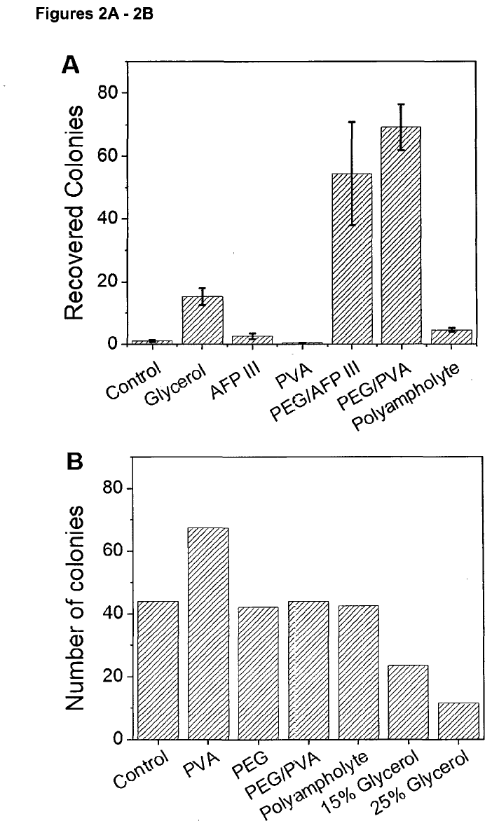

To evaluate the performance of these IRI active polymers versus glycerol, a series of cryopreservation experiments were undertaken. E. coli was added to different cryoprotective formulations and then exposed to 7 freeze/thaw cycles from liquid nitrogen (−196° C.) to room temperature (20° C.) and the number of colony forming units determined by growth on agar plates for 16 hours was recorded (see FIG. 2A). This was chosen to mimic laboratory conditions where stocks are often frozen and thawed during use. 25% glycerol resulted in an average of 15 recovered colonies compared to 1 for no added cryoprotectants. PVA, AFP and the poly(ampholyte) alone gave results identical to no cryoprotectants. (It should be noted that the concentrations of each of the above were chosen based on their relative IRI activity to give similar effects, not at equal mass concentration to enable us to correlate the physical properties to the observed biological responses). PEG was added, and the mixture PEG/PVA (100 mg·mL⁻¹+1 mg·mL⁻¹) was found to dramatically increase recovery to 69 colony forming units, which is a >4 fold increase compared to glycerol alone. PEG/AFP mixtures lead to similar results (52 colonies) supporting the hypothesis that controlling IRI is the key mechanism in protecting bacteria during cryopreservation, by reducing ice growth especially during thawing. The poly(ampholyte)s, however, showed no cryoprotective effect, despite them previously being used for mammalian cells, where they appear to function via cell membrane interactions. Poly(ampholytes) have far weaker IRI than PVA or AFPs and hence this supports a mechanism of protection based on limiting ice recrystallization rather than membrane plasticisation/stabilisation.

### Example 3: Toxicity of Cryopreservatives

A key challenge associated with the use of glycerol is its intrinsic toxicity at cryopreservation concentrations, so the impact of incubating the polymers with E. coli compared to glycerol was evaluated. Each component (at the useful cryopreservation concentration) was incubated with E. coli overnight at 4° C. and subsequently the number of colony forming units determined, FIG. 2B. Glycerol at 15 or 25 wt % led to a significant reduction in recovered colonies. Conversely, none of the polymers showed toxicity to the E. coli. This supports our hypothesis that biomimetic macromolecular antifreezes are ‘spectator additives’ which only function when ice is present, and are ignored by micro-organisms (and indeed other cells) which is crucial for down-stream applications.

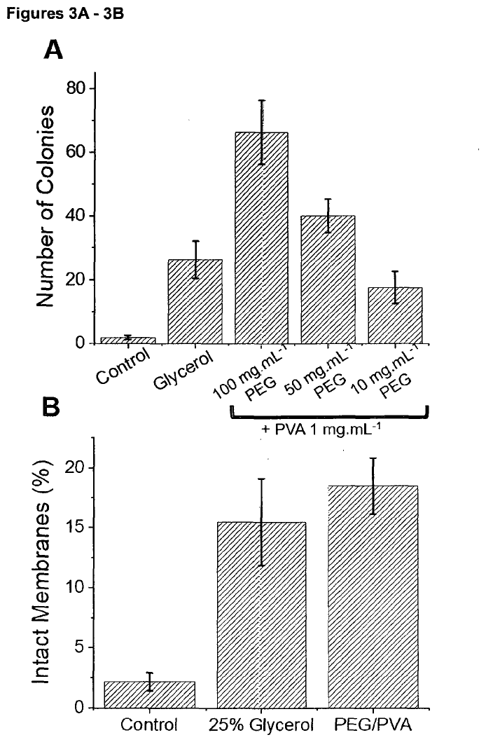

To further optimise this formulation, the PEG concentration was varied from 100 to 10 mg·mL⁻¹, all with addition of 1 mg·mL⁻¹ PVA; and the number of recovered colonies after 7 freeze/thaw cycles was counted (see FIG. 3A). Reducing the concentration of PEG to 50 and 10 mg·mL⁻¹ led to a significant reduction in the number of colonies recovered, compared to 100 mg·mL⁻¹. However, it is important to note that 10 mg·mL⁻¹ PEG with 1 mg·mL⁻¹ PVA is just a 1.1 wt % solution, but it performs as well as 25 wt % glycerol which represents a remarkable cryopreservation outcome with a 25 fold reduction in cryoprotectant. This shows that whilst there is an optimum formulation, there is scope to vary the components and hence supporting ease of use in a realistic laboratory situation. In some down-stream applications, lowering the cryoprotectant concentration, rather than maximising total cell recovery.

The above experiments relied on counting colony-forming units, which shows the application, but does not give insight into the mechanisms of cell stress during freeze/thaw. To assess the bacteria immediately after thawing, confocal microscopy was employed with a live/dead viability assay which measures the integrity of cell membranes (see FIG. 3B). Bacterial cells with intact cell membranes exhibit green fluorescence (SYTO-9 dye) while those with compromised cell membranes exhibit red fluorescence (propidium iodide dye). Following freeze/thaw in PBS alone just 2.2% of the E. coli had intact membranes (green), demonstrating that ice growth causes significant mechanical damage. Post freeze/thaw in either 25% glycerol or PEG/PVA resulted in 15-18% of the E. coli retaining intact membranes. These observations suggest that the mechanism of ice damage limitation of both glycerol and our macromolecular antifreezes is very similar. However, the colony counting results (FIG. 2) confirmed the polymer approach to be superior, supporting a hypothesis that the reduced toxicity of the polymers means that more and healthier colonies can grow post-thaw, and reduced growth inhibition compared to glycerol.

### Example 4: Additional Bacteria Strains for Cryopreservation

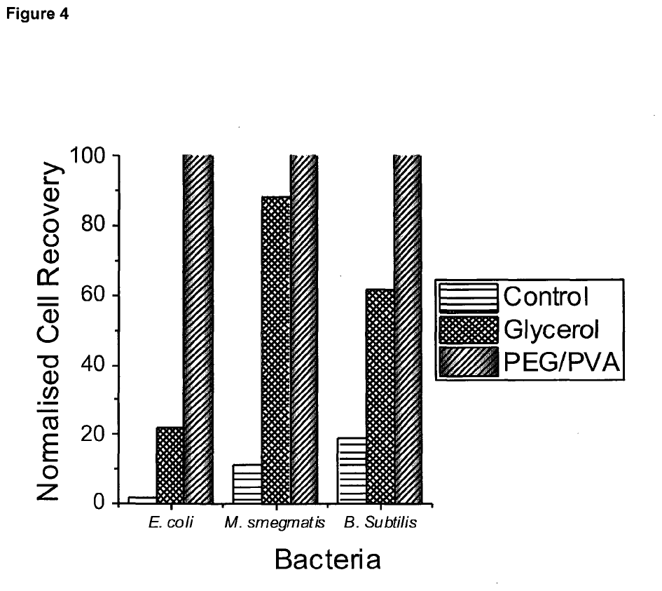

Additional bacteria strains for cryopreservation were selected to cover a wide range of genera to ensure these effects are not unique to E. coli. Bacillus subtilis was chosen as a Gram positive strain and Mycobacterium smegmatis as a Mycobacteria (distinct cell wall compared to other Gram positives) for further analysis. Using the same conditions as for E. coli, the cells were exposed to 7 freeze/thaw cycles and recovered colonies counted, Table 1 and FIG. 4. To enable comparison of the data and to account for the different growth rates of each bacterial strain, the recovered colonies were also normalised to the highest recovery.

TABLE 1
Mean colonies recovered after 7 freeze/thaw cycles.

| | E. coli | | M. smegmatis | | B. subtilis | |
|---|---|---|---|---|---|---|
| | Total | Normalised | Total | Normalised | Total | Normalised |
| | (—) | (%) | (—) | (%) | (—) | (%) |
| Control | 1 ± 0.4 | 1 | 4 ± 0.5 | 12 | 29 ± 10.4 | 11 |
| 25% Glycerol | 15 ± 2.8 | 22 | 30 ± 6.0 | 88 | 93 ± 18.9 | 35 |
| AFPIII | 3 ± 0.9 | 4 | 2 ± 0.3 | 6 | 26 ± 6.7 | 10 |
| PVA | 0 ± 0.1 | 0 | 3 ± 1.5 | 9 | 5 ± 0.7 | 2 |
| PEG | 53 ± 6.7 | 77 | 28 ± 4.3 | 82 | 150 ± 10.7 | 57 |
| PEG/PVA | 69 ± 7.3 | 100 | 34 ± 4.2 | 100 | 262 ± 39.3 | 100 |
| Poly(ampholyte) | 5 ± 0.6 | 7 | 28 ± 4.5 | 82 | 20 ± 5.0 | 8 |

[Glycerol] = 25 wt %; [PEG] = 100 mg · mL⁻¹; [PEG/PVA] = 100 + 1 mg · mL⁻¹ respectively; [AFPIII] = 0.1 mg · mL⁻¹; Poly(ampholyte) = 50 mg · mL⁻¹.
Error represents the SD from minimum of 3 repeats.
Note that the total colonies recovered for each organism varies based on their own growth rates, hence normalised recovery (verses the highest recovery level) is also included.

In all cases, the PEG/PVA mixture gave equal or better levels of recovery than glycerol alone. It was noted that M. smegmatis (which is a slow-growing organism compared to other two) gave fewer colonies after a fixed period of growth in all conditions, but the PEG/PVA still matched the performance of glycerol. In some cases, the PEG alone gave favourable recovery levels also (as any uncharged solute will give some protection) but in all cases addition of PVA increased this recovery, showing it is an essential component to ensure recovery of viable cells, without resorting to multiple rounds of freezing controls. These results demonstrate the versatile nature of this approach, and that replacing glycerol in laboratories with this polymer formulation is a reliable way to match, or improve current storage methods.

### Example 5: Efficacy of Various Formulations

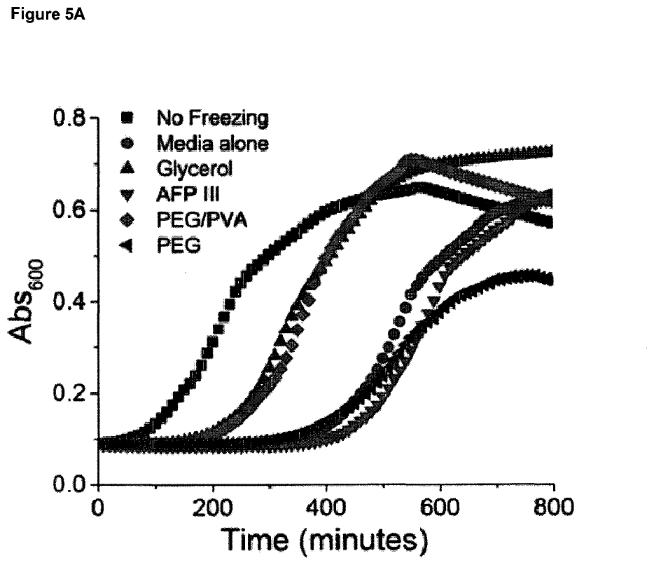

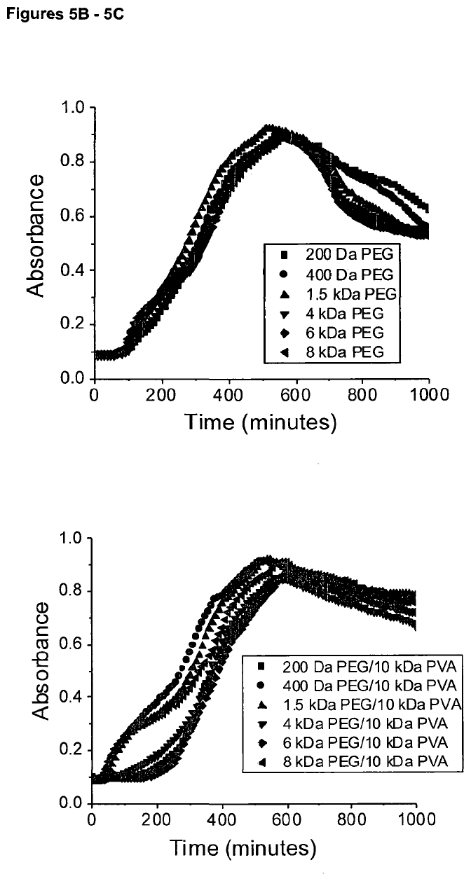

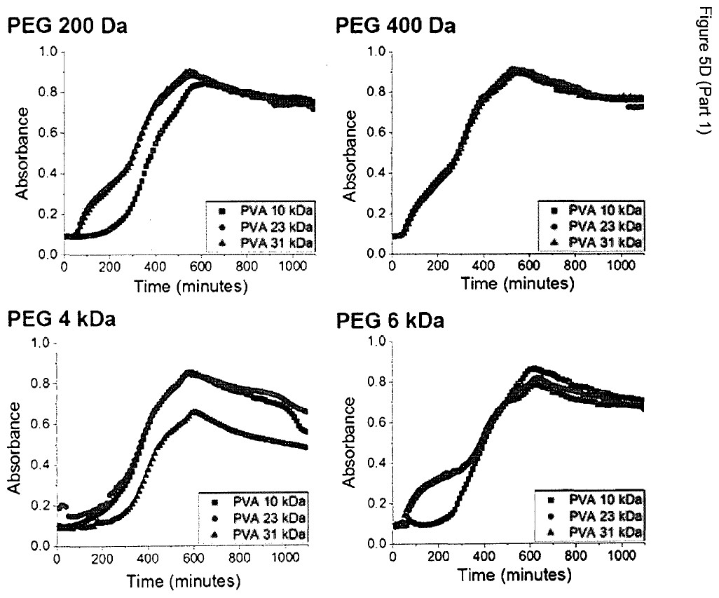

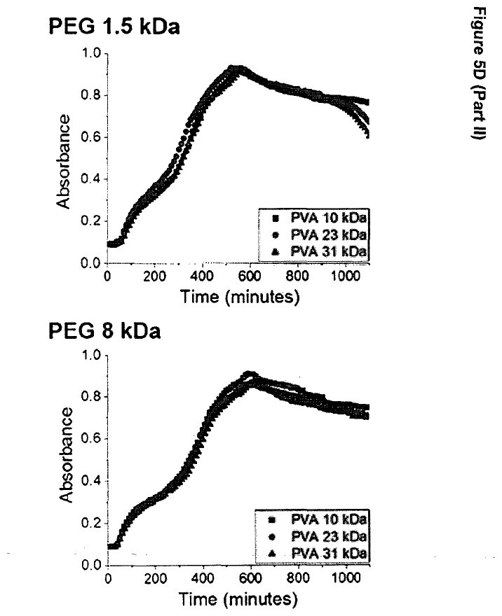

This macromolecular cryoprotection solution using ice-inhibiting polymers is clearly suitable for bacteria storage but there are many parameters which can be varied in this system including the molecular weight of the polymers. To enable a large number of conditions to be screened, the post-thaw growth rate of E. coli was also followed by OD600 (turbidity) measurements, which enable higher-throughput measurements. E. coli were frozen with the indicated formulations, and post-thaw inoculated into LB media and their growth monitored. After 7 freeze/thaw cycles in liquid nitrogen, cells cryopreserved in 25% glycerol and PVA/PEG (100 mg·mL-1 and 1 mg·mL-1 respectively) had essentially identical growth rates (FIG. 5), which were faster than all the other formulations used.

By monitoring growth profiles of E. coli, various formulations and molecular weights of PVA were tested for their efficacy (FIGS. 5B-D). For PVA, 10 kDa and 31 kDa gave approximately identical recovery levels, but 10 kDa is easier to dissolve into media, making it preferable for real-applications where concentrate stock solutions are required. Higher molecular weight PVA can also lead to dynamic ice-shaping which is known to reduce recovery of cells post-thaw. Lower molecular weight PEGs (200-1500 Da) alone appeared to have a slightly greater cryoprotective effect than larger PEGs (4 to 8 kDa), as they reach a higher OD600 and display slower logarithmic decline phases, indicating improved cell health, but these differences were small. Various permutations of PEG/PVA were also screened, and in all cases addition of PVA increased the cryoprotective effect and lengthened the stationary phase of cells. The improvement was most significant in the case of larger PEGs. Considering the cryoprotective effect of each of the mixtures, and the solubility of each of the constituents, it was determined that 10 kDa PVA and 4 kDa PEG were the optimum molecular masses to use to ensure reliable and easy to use cryopreservation.

### Cryopreservation of Proteins

### Materials and Methods

### Protein Freezing

Samples were made in triplicate at the appropriate concentrations and frozen in 1.5 mL tubes by directly placing in a freezer either at −20° C. or −80° C. The samples were then held at this temperature for the indicated time period and then thawed at 20° C.

β-Gal activity

β-Gal activity was determined by a colorimetric assay involving the use of ONPG. Briefly aliquots of 30 μL of 4 mg·mL⁻¹ ONPG were added to wells of a 96 well plate containing 50 μL of 20 μg·mL⁻¹ β-Gal solution. This was then incubated at room temperature for 5 minutes and quenched by addition of 50 μL of 1M Na₂CO₃ solution. Absorbance was measured at 420 nm. All other methods are in the supporting information.

β-galactosidase (β-Gal), glucose-oxidase (GO), o-dianosidine, glucose, horse radish peroxidase (HRP), o-nitrophenyl-β-D-galactoside (ONPG), ethanol, poly(ethylene glycol) (PEG, 2.5 kDa), poly(vinyl pyrolidone) (PVP, 5 kDa), succinic anhydride, aminethyl methacrylate, insulin, rabbit IgG, PEG (4 kDa) and PVA (10, 23 and 30 kDa) and trehalose were purchased from Sigma Aldrich. EvaGreen dye was purchased from VWR chemicals while M13 primers, dNTPs, PCR buffer (including MgCl₂) were purchased from Invitrogen. Rabbit IgG assay kit and Taq polymerase were purchased from Life technologies. cDNA was provided by the lab of Jose Gutierez-Marcos (University of Warwick Life Sciences department). Phosphate-buffered saline (PBS) solution was prepared using preformulated tablets (Sigma-Aldrich) in 200 mL of Milli-Q water (>18.2Ω mean resistivity) to give [NaCl]=0.138 M, [KCl]=0.0027 M, and pH 7.4. Taq polymerase was dialysed against glycerol free taq buffer prior to use using Amicon 0.5 ml centrifugal filters (Merck, Irl) [Tris-HCL]=10 mM, [KCl]=100 mM, [DTT]=1 mM, [EDTA]=0.1 mM, 0.5 wt % Tween 20, 0.5 wt % Triton X. Poly(vinyl alcohol) (PVA, 5.1 kDa) was synthesized. All reagents were used as received unless otherwise stated.

### Physical and Analytically Methods

Absorbance spectroscopy was undertaken using a Synergy HT multi-mode microplate reader (BioTek UK, Bedfordshire, UK). Quantitative polymerase chain reaction (QPCR) was carried out on a real-time PCR detection system while a thermocycler was used for standard PCR reactions. PCR was undertaken using the following protocol, initiation at 94° C. for 1 minute, denaturation at 94° C. for 20 seconds, annealing at 56° C. for 20 seconds and elongation at 72° C. for 30 seconds. Twenty-five cycles were used and followed by a final elongation at 72° C. for 5 minutes. Circular Dichroism (CD) spectra were recorded on a spectropolarimeter (Jasco J-720, Jasco UK) using a data interval of 0.2 nm. The spectrum was measured 16 times and averaged. The spectrum of a blank sample containing only buffer or the appropriate cryoprotectant was then subtracted giving a final spectrum for each protein. Dynamic light scattering was undertaken on a Malvern Zetasizer Nano ZS.

### β-Galactosidase Assay

β-Gal activity was determined by a colorimetric assay involving the use of ONPG. Briefly aliquots of 30 μL of 4 mg·mL-1 ONPG were added to wells of a 96 well plate containing 50 μL of 20 μg·mL⁻¹ B-Gal solution. This was then incubated at room temperature for 5 minutes and quenched by addition of 50 μL of 1M Na₂CO₃ solution. Absorbance was measured at 420 nm.

### Glucose Oxidase Assay

Activity of GO was determined using the oxidation of o-dianosidine through a peroxidase-coupled reaction. Briefly 2.5 mg of o-dianosidine was dissolved in 2 mL of ethanol, which was further diluted by the addition of 8 mL of PBS buffer resulting in a 10 mL stock solution. A Horseradish peroxidase (HRP) stock solution of 100 μg·mL⁻¹ was prepared by dissolving HRP into a solution of 18% w/w glucose in distilled water, while GO samples were prepared at a concentration of 2 μg·mL⁻¹. 30 μL of GO sample was added to 30 μL of HRP solution into separate wells of a 96 well plate, then 150 μL of o-dianosidine was added and the mixture was incubated for 3 minutes. Finally, absorbance was measured at 450 nm.

### Quantitative Polymerase Chain Reaction Assay

Cryoprotectants at required concentrations were added to Taq in the appropriate buffer solution in 20 μL volumes. QPCR was undertaken using standard protocols. EvaGreen dye was used as the DNA-binding fluorescent dye, sample volumes were 20 μL. Briefly, samples of 2.5 μL PCR buffer, 1 μL dNTPs, 1.5 μL Eva Green fluorescent dye, 1 μL forward and reverse primers, 1 μL of Taq at 1.25 U. μL⁻¹ and 12 μL PCR water, were prepared. Samples were tested in triplicate with three dilutions of template DNA at 20, 10 and 5 ng, with appropriate positive and negative controls.

### Recombinant Expression and Purification of GFP

A pWALDO plasmid encoding for a hexahistidine-tagged GFP was kindly provided by Elizabeth Fullam (Warwick University, Coventry, UK). The plasmid was transformed into competent Escherichia coli BL21(DE3) cells (New England Biolabs). A colony was selected to inoculate 50 mL of LB-medium containing 100 μg/mL ampicillin and was grown overnight at 37° C. under continuous shaking of 180 rpm. The following day, 5 mL of the preculture was added to 500 mL of LB-medium in a 2 L Erlenmeyer flask and grown at 37° C. for 4 hours with a shaking speed of 180 rpm. The temperature was then reduced to 16° C. and the cells incubated for another hour before adding IPTG to a final concentration of 1 mM. The overexpression of the protein was allowed to take place overnight following which the cells were centrifuged at 4000 g for 30 minutes at 4° C.

Pelleted cells were resuspended in PBS supplemented with Pierce protease inhibitor mini-tablets. The suspension was passed through a STANSTED ‘Pressure Cell’ FPG12800 homogeniser in order to lyse the cells. The cell lysate was centrifuged at 14,000 g and the supernatant applied to an IMAC Sepharose 6 Fast Flow (GE Healthcare) column charged with Ni(II) ions and pre-equilibrated with PBS. The column was washed with 10 column volumes of 20 mM imidazole in PBS followed by 5 column volumes of 50 mM imidazole in PBS. Bound GFP was eluted using 250 mM (or 1000 mM) Imidazole in PBS. Imidazole was removed from the fractions containing GFP using PD10 desalting columns (GE Healthcare). Purity was estimated using SDS-PAGE and protein concentration determined using Thermo Scientific Pierce BCA assay kit. Various volumes of the GFP containing PBS solution were aliquoted into 1.5 mL microcentrifuge tubes and snap-frozen in liquid nitrogen to store at −80° C. till required.

### Green Fluorescence Protein Stability Assay

200 μL of 6.89 mg·mL⁻¹ green fluorescent protein (GFP) was diluted in 39.8 mL PBS buffer resulting in a stock solution of 0.034 mg·mL-1. PEG and PVA were dissolved in 2 mL of the stock solution to make different samples with final concentrations of 100 mg·mL⁻¹ PEG and 0.5, 1, 2.5, 5 and 10 mg·mL⁻¹ PVA. This was repeated for all 3 different molecular weights of PVA tested. Aliquots of 80 μL of the GFP/PEG/PVA solution were pipetted into wells of a black 96 well plate and fluorescence recorded at 27° C. Fluorescence intensity was compared to that of a GFP/PEG solution with a 100 mg·mL⁻¹ concentration. The plates were placed in a freezer at −20° C. until frozen and then thawed in an Eppendorf SmartBlock™ at 27° C. for 10 minutes. The above freeze-thaw cycle was repeated 6 times with the fluorescence of the samples recorded after each thaw. Fluorescence excitation was measured at 485/20 nm and emission at 528/20 nm.

### Insulin Freeze-Thaw Assay

1 mL of 10.5 mg·mL⁻¹ insulin was diluted in 19 mL PBS buffer resulting in a stock solution of 0.525 mg·mL⁻¹. PEG and PVA were dissolved in the stock solution to make different samples with final concentrations of 100 mg·mL⁻¹ 4 kDa PEG, 50 mg·mL⁻¹ 2 kDa PEG and 1 mg·mL⁻¹ PVA. Insulin in PBS buffer was used as a control against solutions of Insulin/PVA, Insulin/PEG2/PVA and Insulin/PEG4/PVA. The samples were placed in a freezer at −20° C. for 1 hour until frozen and then thawed in an Eppendorf SmartBlock™ at 37° C. for 15 minutes. The above freeze-thaw cycle was repeated for 6 and then 12 thaws before hydrodynamic diameter being measured by dynamic light scattering.

### Rabbit IgG Assay

Activity of rabbit IgG was determined using an “Easy-Titer rabbit IgG assay kit (Life Technologies). 125 μL Solutions of 125 μg·mL⁻¹ of IgG were prepared and frozen for 4 days. Upon thawing, 20 μL of IgG sensitized beads were pipetted into wells of a 96 well plate and 20 μL of IgG solution was added. The plate was then incubated under shaking for 5 minutes at room temperature after which 100 μL of blocking buffer was added and the plate was incubated for a further 5 minutes. Absorbance was measured at 405 nm using a plate reader, and samples were compared to a freshly made up positive control.

### Freeze-Thaw Methodology

Samples were made in triplicate at the appropriate concentrations and frozen by placing in a freezer either at −20° C. or −80° C. The samples were then held at this temperature within the freezer for the appropriate amount of time and then thawed on the bench top.

### Example 6: Ice Recrystallisation Assays with Various Polymers

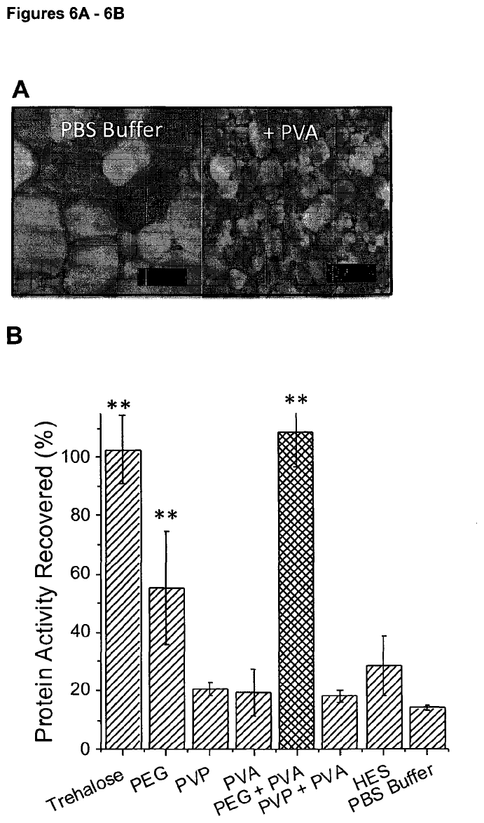

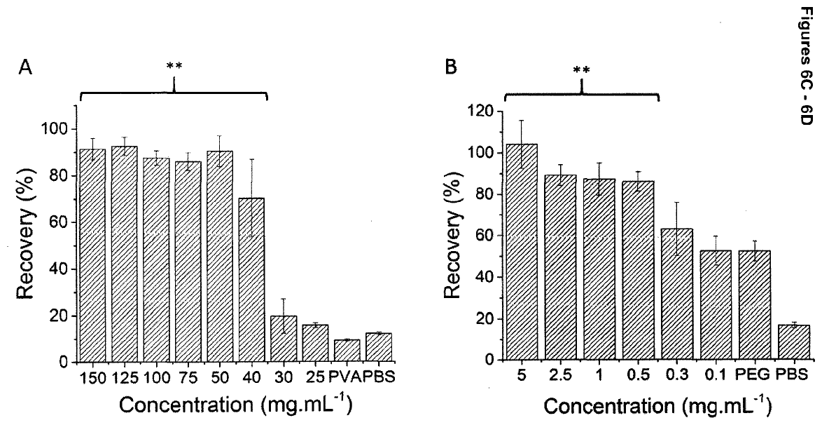

The aim of this study was to investigate the ability and utility of polymeric IRI's as ‘polymer-only’ protein stabilising agents. Ice recrystallization assays showed that ice crystals grown and held at sub-zero temperatures in the presence of PVA (0.1-5 mg·mL⁻¹) are significantly smaller than those grown without (FIG. 6A). Any proteins present in a normal frozen formulation would be excluded from the ice crystals and hence aggregation (and inactivation) is more likely as the ice crystal size increases, and protein-protein distance decreases. Therefore, we decided to investigate the ability of polymeric IRI's as non-covalent protein stabilizers to prevent these deleterious effects.

An initial screen for cryo-protection/damage was conducted using bacterial β—galactosidase (β-Gal). β-Gal was frozen at −20° C. for 3 days in the presence of trehalose (as a positive control), PVA or various polymers (HES, PVP, PEG) which are known to have no IRI activity. Activity was tested after thawing at 20° C. (FIG. 6B).

As expected, trehalose protected β-Gal activity during the freezing, as it is a well-known protective osmolyte. All other additives failed to protect when used individually, apart from PEG which gave some protection (FIG. 6B). It should be noted that PEG has known cryoprotectant properties at very high concentrations. When PEG (100 mg·mL⁻¹) and PVA (1 mg·mL⁻¹) were combined, a synergistic cryoprotective effect was observed, reaching values equivalent to trehalose (FIG. 6B). The combination of PEG/PVA appears to be unique since PVP/PVA mixtures were no different from individual additives. Variable concentration studies (FIGS. 6C-D) show that the PEG concentration could be lowered (at constant [PVA]) as low as 50 mg·mL⁻¹ without affecting recovery, but below 30 mg·mL⁻¹ there was no protection.

### Example 7: Polyampholyte

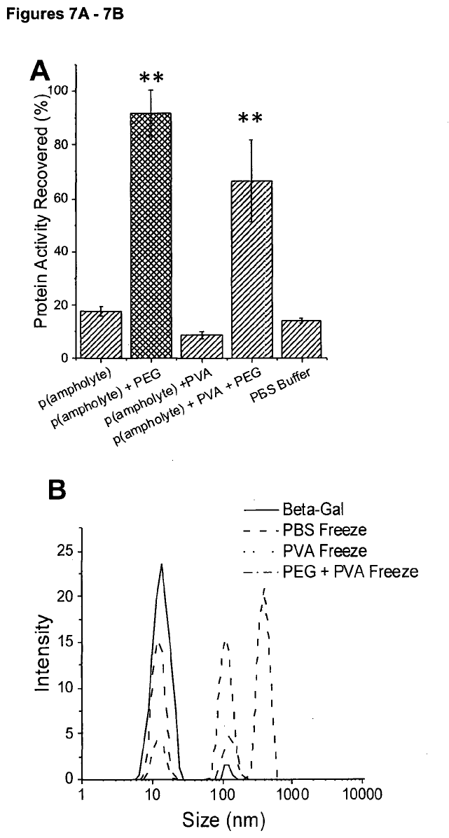

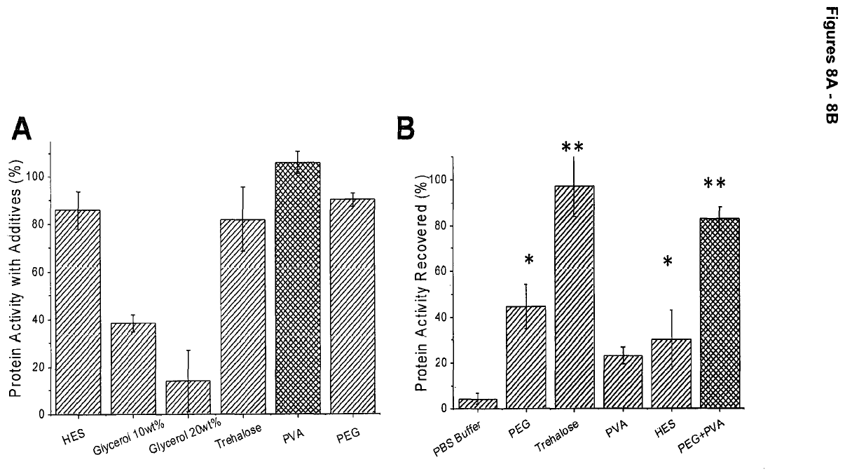

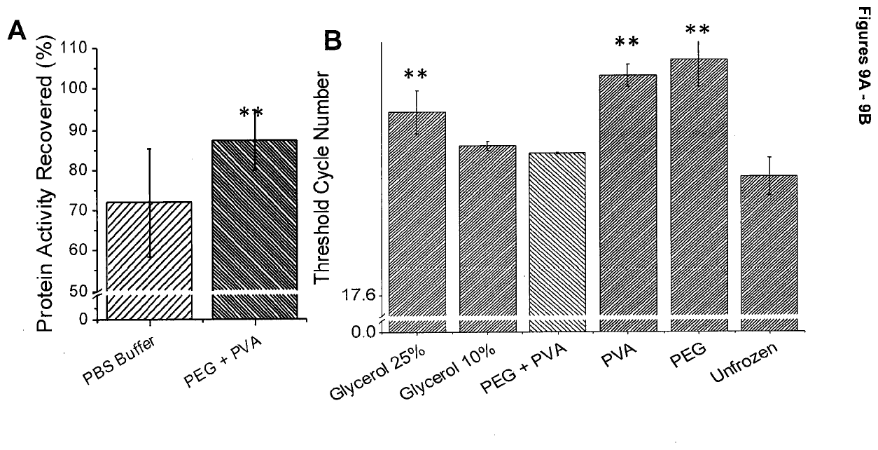

We hypothesised that the role of PVA in enhancing protein cryostorage is due to its IRI activity. To test this hypothesis, we tested another IRI-active polymer (a poly(ampholyte)) developed in our laboratory. Because the poly(ampholyte) is less active, we employed a concentration to achieve equal IRI activity comparable to that of PVA at 1 mg·mL⁻¹. Under identical conditions, we found that the poly(ampholyte) and PVA displayed identical cryoprotectant properties (FIG. 7A). This data proves that ice growth is the major cause of protein de-activation and that the rational design of IRI-macromolecules is an effective strategy for the discovery of new protein stabilisers.

To investigate if preventing protein aggregation was a critical factor for protein cryoprotection, we employed dynamic light scattering (DLS). When β-Gal was freeze/thawed in PBS alone, large aggregates could be seen (>500 nm in diameter) (FIG. 7B). Similarly, large aggregates were also observed when only PVA polymers were employed. Conversely, PEG/PVA mixtures prevent all freeze-induced aggregation, (FIG. 7B).

### Example 8: Effect of Various Preservatives on Protein Function

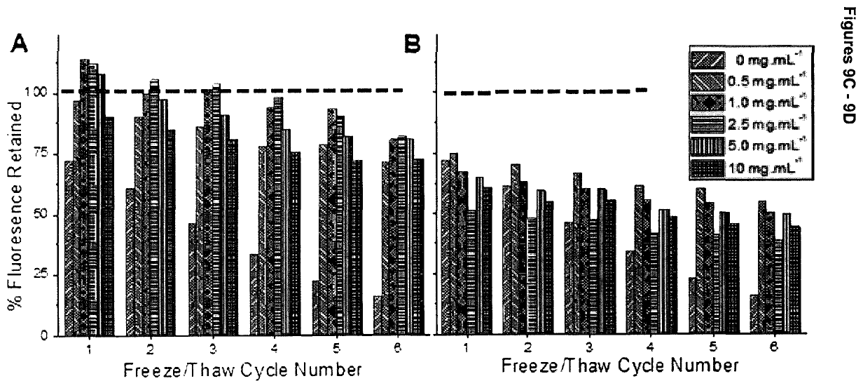

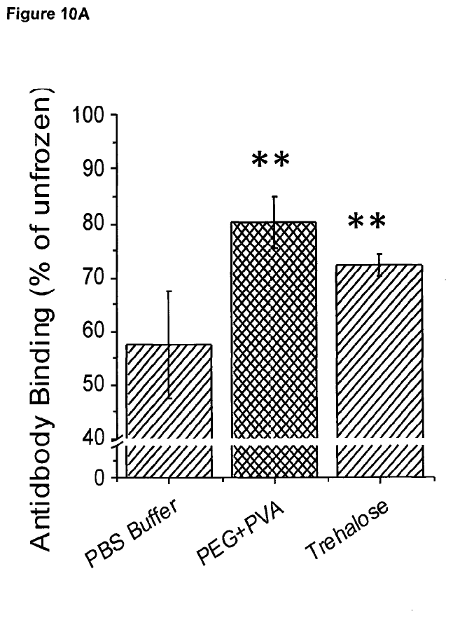

To confirm that the PEG/PVA polymers are passive additives during normal function, we incubated β-Gal with different concentrations of cryoprotectants and tested its activity (FIG. 8A). As expected, glycerol significantly impaired protein function, but both PEG and PVA had little impact on protein function thus indicating that they are biologically inert. Unexpectedly, we also observed some negative effects on protein function for trehalose (see FIG. 8A), justifying our innovative approach. Since under standard laboratory conditions, proteins are normally stored at −80° C. through long periods, we decided to test the levels of protein activity after long term ultra-low temperature conditions. We found that PEG/PVA mixture enabled recovery comparable to trehalose (FIG. 8B), reinforcing the view that the PEG/PVA combination displays high cryoprotective properties.

### Example 9: Effect of Various Preservatives on Enzyme Activity

To ensure these observations were not unique to a single enzyme, we set out to study a range of other proteins using this methodology. Glucose oxidase (GOX) is widely used in sensing, the food industry and in molecular biology, whilst hyperthermophylic DNA polymerase Thermus thermophilus (Taq) is commonly used in diagnostics for the amplification of DNA through the polymerase chain reaction (PCR). We found that GOX was relatively stable after freeze-thawing in only PBS; however, addition of IRI active polymers did increase the recovered enzymatic activity (FIG. 9A).

To assess the activity of Taq enzyme after freeze-thawing, we used quantitative PCR (qPCR). This methodology uses DNA binding fluorophores to detect DNA molecules newly synthesised by the thermostable DNA polymerase. In this assay, fewer cycles mean more activity. We observed that compared to glycerol PEG/PVA improved stability to the extent that it was comparable to fresh recombinantly-expressed enzyme.

In order to more closely reproduce laboratory or clinical settings where protein samples are often removed and replaced from a freezer, a freeze/thaw cycle assay was developed which is also a very stern test of the technology. To enable continual monitoring of the same sample through many freeze/thaw cycles, recombinant green fluorescence protein was used. Upon denaturation, the fluorescence decreases providing a convenient readout. FIG. 9B shows the recovery of florescence following 6 freeze (−20° C.) and thaw (20° C.) cycles. For PEG alone, there was a dramatic reduction in fluorescence with only 15% remaining after 6 cycles. Addition of 1 mg·mL⁻¹ PVA was found to be optimal, enabling >75% activity retention after 6 freeze/thaw cycles. Higher concentrations of PVA were found to be detrimental as was the use of higher molecular weight PVA (23 kg·mol⁻¹). We hypothesise this is due to dynamic ice shaping—a common side effect of antifreeze proteins, which is known to compromise cell cryopreservation.

### Example 10: Effect of Various Preservatives on Therapeutic Protein Activity

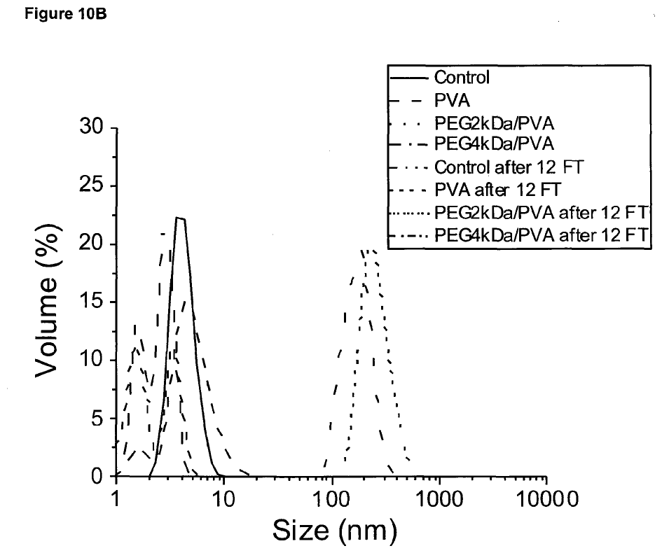

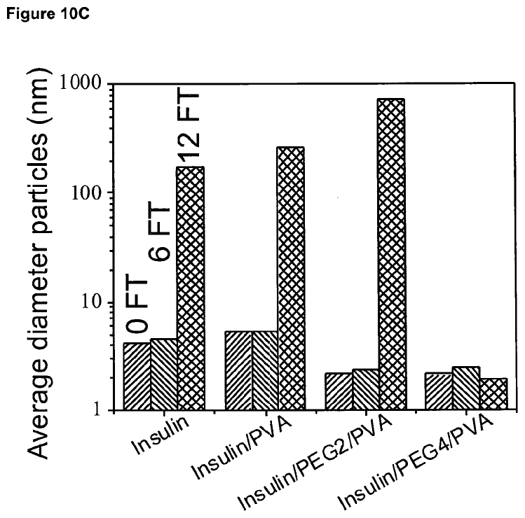

To determine if this methodology could be used for therapeutic proteins as well as those described above, an antibody (rabbit IgG) and insulin were both tested. Rabbit IgG purified extract was stored at −20° C. for 3 days and function determined using an ELISA-based assay. As with all the other proteins tested the PEG/PVA mixture greatly enhanced IgG activity (>80%), (see FIG. 10). The recovery level was superior to that of trehalose.

Insulin is deactivated upon liquid storage by simple agitation or by irreversible aggregation. Dynamic light scattering was therefore employed to probe for the preventing of irreversible insulin aggregation upon freeze thaw using a range of conditions (see FIG. 10C).

### Example 11: Freezing of E. coli in Liquid Nitrogen and Storage at −20° C.

After freezing aliquots of E. coli in liquid nitrogen (−196° C.), the aliquots were stored in a freezer at −20° C. for one week. The number of colonies obtained from equal aliquots was then counted. 100 mg/ml 4 kDa PEG and 1 mg/ml 10 kDa PVA were used. The results were compared against a 25 wt % (final concentration) glycerol solution and an LB media control (PBS without any cryoprotectant mixed in a 1:1 ratio with cells in LB media).

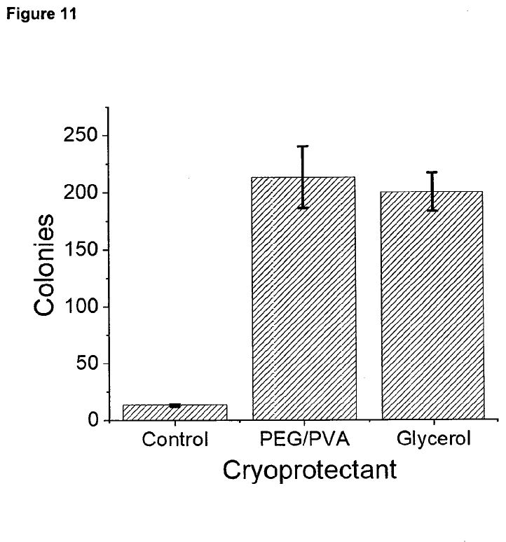

The results (FIG. 11) show that the 100 mg/ml 4 kDa PEG and 1 mg/ml 10 kDa PVA formulation was as efficacious as the glycerol solution.

1. A composition comprising:
(a) 0.1-40 mg/ml polyvinyl alcohol (PVA), and
(b) 10-400 mg/ml poly-ethylene glycol (PEG).

2. A composition as claimed in claim 1, wherein:
(a) the PVA concentration is 0.5 mg/mL to 10 mg/mL, preferably 0.7 mg/mL to 5 mg/mL, and more preferably about 1 mg/mL, wherein the composition additionally comprises biological material for cryopreservation; or
(b) the PVA concentration is 1.0 mg/mL to 20 mg/mL, preferably 1.4 mg/mL to 10 mg/mL, and more preferably about 2 mg/mL.

3. A composition as claimed in claim 1 or claim 2, wherein the PVA has a weight average molecular weight of 1-80 kDa or 3-50 kDa.

4. A composition as claimed in claim 3, wherein the PVA has a weight average molecular weight of 5-40 kDa or 6-14 kDa, preferably 7-13 kDa, more preferably 8-12 kDa or 9-11 kDa, and most preferably about 10 kDa.

5. A composition as claimed in any one of the preceding claims, wherein:
(a) the PEG concentration is 75-125 mg/mL, preferably about 100 mg/mL, wherein the composition additionally comprises biological material for cryopreservation; or
(b) the PEG concentration is 150-250 mg/mL, preferably about 200 mg/mL.

6. A composition as claimed in any one of the preceding claims, wherein the PEG has a weight average molecular weight of 100 Da to 100 kDa.

7. A composition as claimed in claim 6, wherein the PEG has a weight average molecular weight of 200 Da-50 kDa, 1-25 kDa, 1-15 kDa, 2-10 kDa, or 3-5 kDa, preferably about 4 kDa.

8. A composition as claimed in claim 1, wherein the composition comprises:
(a) 0.5-5 mg/mL or 1.0-10 mg/mL PVA having a weight average molecular weight of 5-15 kDa; and
(b) 50-150 mg/mL or 100-300 mg/mL PEG having a weight average molecular weight of about 3-6 kDa.

9. A composition as claimed in claim 8, wherein the composition comprises:
(a) about 1 mg/mL or about 2 mg/mL PVA having a weight average molecular weight of about 10 kDa; and
(b) about 100 mg/mL or about 200 mg/mL PEG having a weight average molecular weight of about 4 kDa.

10. A composition as claimed in any one of the preceding claims, wherein the composition additionally comprises one or more components selected from the group consisting of an aqueous buffer, an antibiotic, a sugar, an anticoagulant, an antioxidant, glycerol, DMSO and a pH indicator.

11. A composition as claimed in claim 10, wherein the composition comprises 0-10% glycerol, preferably 0-1% glycerol.

12. A composition as claimed in any one of the preceding claims, wherein the composition comprises an amount of one or more organic solvents (e.g. DMSO or glycerol) which are insufficient to promote or induce vitrification of the composition upon freezing, or no organic solvents.

13. A composition as claimed in any one of the preceding claims, wherein the composition additionally comprises biological material.

14. A composition as claimed in claim 13, wherein the biological material is selected from the group consisting of cells, tissues, whole organs and parts of organs, viruses, proteins, nucleic acids, and complexes between proteins and nucleic acids.

15. A composition as claimed in claim 14, wherein the cells are prokaryotic cells, preferably bacterial cells.

16. A composition as claimed in claim 14, wherein the biological material comprises purified proteins, preferably enzymes, therapeutic proteins, diagnostic proteins or antibodies.

17. A composition as claimed in any one of claims 13-16, wherein the composition is is frozen, preferably at a temperature of less than 0° C., more preferably less than −5° C., −20° C. or −60° C.

18. A kit comprising:
(a) PVA having weight average molecular weight of 5-40 kDa; and
(b) PEG having a weight average molecular weight of 1-15 kDa,
and optionally
(c) one or more components selected from an aqueous buffer, a sugar, an antibiotic, an anticoagulant, an antioxidant, pH indicator and 0-15% glycerol, (preferably 0-1% glycerol).

19. Use of a composition as claimed in any one of claims 1 to 12 for the cryopreservation of biological material, preferably for the cryopreservation of bacterial cells.

20. A process for producing a cryopreserved composition comprising biological material, comprising the step:
(a) freezing a biological material at a cryopreserving temperature in a composition as claimed in any one of claims 1 to 12.

21. A process for producing a cryopreserved composition comprising biological material, the process comprising the steps:
(a) freezing a biological material, wherein the biological material comprises or consists of prokaryotic (preferably bacterial) cells to a temperature of −70° C. to −200° C. (preferably about −80° C. or about 196° C.) in a composition as claimed in any one of claims 1 to 12; and
(b) storing the frozen biological material at a temperature of −10° C. to −30° C. (preferably about −20° C.).

22. A process for producing a biological material, comprising the steps:
(a) thawing a composition comprising biological material as claimed in any one of claims 13 to 17; and optionally
(b) removing and/or isolating the biological material from the composition.
